(19) United States
(12) Patent Application Publication
(10) Pub. No.: US 2008/0242149 A1
(43) Pub. Date: Oct. 2, 2008

(54) Receptacle, plug, and connector apparatus

(75) Inventors: Takeshi Konno, Tokyo (JP); Yoshinori Ohta, Tokyo (JP); Shinichi Tamura, Tokyo (JP); Hirotaka Yamamoto, Kanagawa (JP); Masahiko Seki, Chiba (JP); Kazutaka Nakashima, Chiba (JP)

Correspondence Address: NATH & ASSOCIATES, PLLC;Sixth Floor, 1030 15th Street, N.W., Washington, DC, 20005, US

(73) Assignees: MITSUMI ELECTRIC CO., LTD., Tokyo (JP); SONY CORPORATION, Tokyo (JP)

(21) Appl. No.: 12/078,249

(22) Filed: Mar. 28, 2008

(30) Foreign Application Priority Data
Mar. 29, 2007 (JP) 2007-088633

(51) Int. Cl. H01R 13/648

(52) U.S. Cl. 439/607

(57) ABSTRACT

A receptacle is provided that transmits another signal separate from a USB module compatible signal, without the occurrence of a fault, when a USB connection is made. This receptacle (200) has a USB terminal section (210) that connects to a USB terminal section (310) and an other terminal section (220) that connects to an other terminal section (320) of a plug (300) at positions staggered in a direction orthogonal to the direction of insertion, and the direction of insertion, of the plug (300) that mates by being inserted into a receptacle housing (240) inside a shield case (230). The plug (300) has the USB terminal section (310) and the other terminal section (320) staggered in a direction orthogonal to the direction of insertion, and the direction of insertion, inside a shield case (330) that fits inside the shield case (230), corresponding to the position of the USB terminal section (210) of the receptacle (200) and the other terminal section (320).

### CROSS REFERENCE TO RELATED APPLICATIONS

The disclosure of Japanese Patent Application No. 2007-88633, filed on Mar. 29, 2007, including the specification, drawings and abstract is incorporated herein by reference in its entirety.

### BACKGROUND OF THE INVENTION

1. Field of the Invention

The present invention relates to a receptacle, a plug connected to this receptacle, and a connector apparatus provided with these, and more particularly to a receptacle, plug, and connector apparatus compatible with the USB (Universal Serial Bus) standard.

2. Description of the Related Art

A USB transmission interface (Series A terminal, hereinafter also referred to as “USB-A”) compatible with the USB standard, a standard for a data transmission path connecting a peripheral device such as a keyboard, mouse, or modem and a personal computer or IA (Information Appliance), has become widely used.

Features of this USB include the ability to connect peripheral devices such as a keyboard, mouse, modem, and joystick to a personal computer with a single interface, together with ease of connection and low cost of parts.

A well-known USB connector apparatus has a USB plug (Series A Plug), and a USB socket (Series A Receptacle) connected to the USB plug (Series A Plug).

A USB plug is attached to the end of a cable connected to a storage medium such as a portable disk, MP3 player, digital pen recorder, or the like, for example, and is formed by covering a substrate section (also referred to as a “base section”) on which a plurality of connecting terminals are fixed to the surface with an annular metal case layer.

This base section is configured by being tightly joined onto the bottom surface of the case layer inside the metal case layer, and inside the case layer there is a connective gripping layer provided to connect to a USB socket (Series A Receptacle) between the bottom surface of the base section and the top surface of the inner side of the case layer.

Meanwhile, a USB socket to which a USB plug is connected has a metal case that fits over the case layer of the USB plug, and a gripping plate section (projecting plate section) whose periphery is covered by the case, and that is inserted into the connective gripping layer of the USB plug and is gripped between the case layer and the base section. On the bottom surface of the gripping plate section, contact pins that are connected to connecting terminals are provided, and these contact pins are connected to connecting terminals when a USB plug is connected to the USB socket.

Through insertion of a USB plug into a USB socket (Series A Receptacle), the connected plurality of connecting terminals function as operating VCC power supply circuit, GND power supply circuit, D+ data transmission circuit, and D− data transmission circuit terminals, respectively. The D+ data transmission circuit terminal and D− data transmission circuit terminal are used for data transmission, and the VCC power supply circuit terminal and GND power supply circuit terminal can receive operating current supplied by a USB host or power supply unit.

In the following description, the VCC power supply circuit, GND power supply circuit, D+ data transmission circuit, and D− data transmission circuit terminals provided in a USB interface are referred to as USB terminals, and these are collectively referred to by the term USB terminal section.

With this kind of USB (Series A) connector apparatus, there are only four USB terminals, and therefore the idea has been conceived of transmitting more information by increasing the number of signal transmission terminals.

For example, there is a version in which another connecting terminal for transmitting a different signal is provided between connecting terminals on the surface of the plate section of an above-described USB plug, and a contact pin is formed on the USB socket gripping plate section at a position corresponding to the other connecting terminal on the base section in the connected USB plug.

However, with this configuration, since another connecting terminal is provided between the connecting terminals forming the USB terminal section in both the plug and the socket, the terminal pitch is narrow and possible shorting of adjacent connecting terminals due to contamination by dust or other foreign matter is a concern.

In Unexamined Japanese Patent Publication No. 2002-315071, for example, a configuration is disclosed in which a separate connecting terminal that transmits a different signal from that of the connecting terminals on the upper surface of the plate section in the metal case layer in a plug is provided on the underside of the plate section, and is connected by inserting a corresponding jack into the socket.

According to this Unexamined Japanese Patent Publication No. 2002-315071, the metal case layer covering the base section of a plug is fitted to the plate section so as to cover both sides and the upper surface of the plate section, and the separate connecting terminal on the underside of the plate section projects downward from the underside of the case layer. On the other hand, in the jack into which the plug is inserted, a terminal section corresponding to the separate connecting terminal of the plug is positioned inside the case opposite and at a predetermined distance from the gripping plate section.

When a plug configured in this way is inserted into the jack, the USB terminal sections are connected, and connecting terminal sections separate from the USB terminal sections are connected.

However, a problem with the configuration shown in Unexamined Japanese Patent Publication No. 2002-315071 is that, since the connecting terminal section separate from the USB terminal section in the socket is positioned opposite the USB terminal section, and is simultaneously connected to the USB terminal section when a plug is inserted, there is a risk of a fault occurring due to shorting between the separate connecting terminal and a connecting terminal if the inside of the socket is contaminated with dust or other foreign matter.

Also, in the jack in Unexamined Japanese Patent Publication No. 2002-315071, the other connecting terminal is exposed outside the underside of the shield case, and therefore the possibility of contact with another electrically conductive member and the occurrence of a fault such as a short is greater than when the periphery is covered by the case.

### SUMMARY OF THE INVENTION

It is an object of the present invention to provide a receptacle, plug, and connector apparatus capable of transmitting another signal separate from a signal transmitted by certain terminal sections, such as a USB module compatible signal, without the occurrence of a fault, when certain terminal sections are connected, such as in USB connection.

According to an aspect of the present invention, the above object is achieved by means of a configuration whereby a receptacle that mates with and is connected to an inserted plug is equipped with a first connected terminal section and a second connected terminal section that are connected respectively to a first connecting terminal section and second connecting terminal section of the plug; wherein the respective contact positions of the first connected terminal section and second connected terminal section corresponding respectively to the first connecting terminal section and the second connecting terminal section are positions that are staggered in the direction of insertion of the plug.

According to another aspect of the present invention, the above object is achieved by means of a configuration whereby a plug that is connected by being inserted into and mating with a receptacle is equipped with a first connecting terminal section and a second connecting terminal section that are connected respectively to a first connected terminal section and second connected terminal section of the receptacle; wherein the contact positions of the first connecting terminal section and second connecting terminal section corresponding respectively to the first connected terminal section and the second connected terminal section are positions that are staggered in the direction of insertion of the plug.

According to still another aspect of the present invention, the above object is achieved by means of a configuration comprising a plug that is equipped with a first connecting terminal section and a second connecting terminal section, and a receptacle equipped with a first connected terminal section and second connected terminal section that are connected to the first connecting terminal section and the second connecting terminal section respectively by the plug being inserted and mating; wherein the contact positions of the first connecting terminal section and the first connected terminal section, and the contact positions of the second connecting terminal section and the second connected terminal section, are staggered in the direction of insertion of the plug.

According to the present invention, it is possible to transmit a separate signal other than a signal transmitted by certain terminal sections, such as a USB module compatible signal, without the occurrence of a fault, when certain terminal sections are connected, such as in USB connection.

### BRIEF DESCRIPTION OF THE DRAWINGS

FIG. 1 is a schematic cross-sectional side view showing the principal parts of a connector apparatus in a state in which a receptacle and plug are mated according to Embodiment 1 of the present invention;

FIG. 2 is a schematic cross-sectional side view showing the configuration of a receptacle according to Embodiment 1 of the present invention;

FIG. 3 is a plan view of a receptacle according to Embodiment 1 of the present invention;

FIG. 4 is a side view of a receptacle according to Embodiment 1 of the present invention;

FIG. 5 is a front view of a receptacle according to Embodiment 1 of the present invention;

FIG. 6 is a front view of a plug according to Embodiment 1;

FIG. 7 is a schematic cross-sectional side view showing the principal-part configuration of a plug according to Embodiment 1 of the present invention;

FIG. 8 is a plan view of a plug according to Embodiment 1 of the present invention;

FIG. 9 is a side view of a plug according to Embodiment 1 of the present invention;

FIG. 10 is an underside view of a plug according to Embodiment 1 of the present invention;

FIG. 11 is a schematic cross-sectional side view showing a state in which only USB connection has been performed in a connector apparatus according to Embodiment 1 of the present invention;

FIG. 12 is a schematic cross-sectional side view showing a state in which a conventional plug that is a conventional USB standard plug has been inserted into a receptacle in a connector apparatus according to Embodiment 1 of the present invention;

FIG. 13 is a schematic cross-sectional side view showing a state in which a plug according to Embodiment 1 of the present invention has been connected to a conventional USB socket;

FIG. 14 is a schematic cross-sectional side view of a connector apparatus showing a state in which a receptacle and plug according to Embodiment 2 of the present invention have been mated;

FIG. 15 is a cross-sectional view through line X-X shown in FIG. 14;

FIG. 16 is a front view of a receptacle according to Embodiment 2 of the present invention;

FIG. 17 is a cross-sectional view through line Y-Y shown in FIG. 16;

FIG. 18 is a front view of a plug according to Embodiment 2 of the present invention;

FIG. 19 is a cross-sectional view through line Z-Z shown in FIG. 18; and

FIG. 20 is a drawing showing a state in which a plug according to Embodiment 2 of the present invention has been connected to a conventional USB socket.

### DETAILED DESCRIPTION OF THE PREFERRED EMBODIMENTS

With reference now to the accompanying drawings, embodiments of the present invention will be explained in detail below. Regarding the concepts of front and rear in the embodiments, for a plug the end inserted is described as the front, and for a receptacle the end at which a plug is inserted is described as the front.

### Embodiment 1

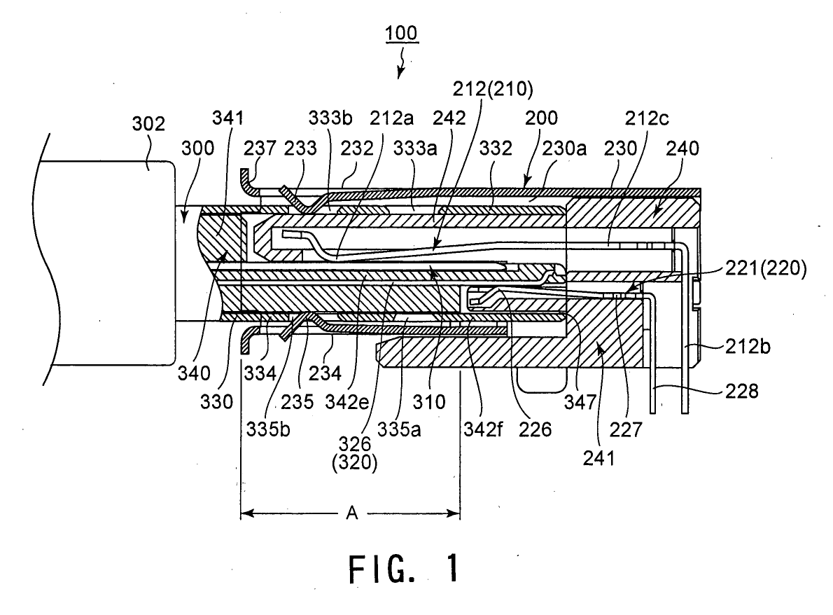

FIG. 1 is a schematic cross-sectional side view of a connector apparatus 100 in a state in which a receptacle and plug are mated according to Embodiment 1 of the present invention.

Connector apparatus 100 shown in FIG. 1 is provided with a receptacle 200, and a plug 300 that is inserted into receptacle 200 and is thereby mated therewith and forms a USB connection with receptacle 200, and is capable of transmitting a separate signal different from a USB signal.

With connector apparatus 100 shown in FIG. 1, when plug 300 is mated with receptacle 200, first terminal sections 210 and 310 and second terminal sections 220 and 320 that transmit a different signal from the signal transmitted by first terminal sections 210 and 310 of receptacle 200 and plug 300 are connected.

First terminal sections 210 and 310 provided in receptacle 200 and plug 300 respectively may be terminal sections that transmit any kind of signal by means of connection, but first terminal sections 210 and 310 are here described as USB terminal sections that are compatible with the USB-A standard.

Also, second terminal sections 220 and 320 are described as other connecting terminal sections (hereinafter referred to as “other terminal sections”) 220 and 330 for transmitting a signal separate from the USB signal transmitted by the connection of first terminal sections 210 and 310.

A signal transmitted by other terminal sections 220 and 320 may be, for example, a separate signal other than a USB signal to another device between USB-connected devices respectively equipped with a receptacle 200 and plug 300, such as an AD value for distinguishing the type of the other device, data for performing control of the other device, GND, or left/right voice signals. Through the connection of second terminal sections 220 and 320 in this way, it is possible for data reading/writing and operational control of one device by the other to be performed via a USB connection between devices respectively equipped with other terminal sections 220 and 320.

In the following description, USB terminal section 310 and other terminal section 320 on the plug 300 side are described as connected terminal sections vis-à-vis USB terminal section 210 and other terminal section 220 on the receptacle 200 side, but this is not a limitation. That is to say, USB terminal section 210 and other terminal section 220 on the receptacle 200 side may be assumed to be connected vis-à-vis USB terminal section 310 and other terminal section 320 on the plug 300 side.

Thus, with connector apparatus 100 of this embodiment, through the mating of receptacle 200 and plug 300, first terminal sections 210 and 310 and second terminal sections 220 and 320 are connected, and a USB signal and a separate signal different from a USB signal are transmitted. As described later herein, the shapes of the connecting ends of receptacle 200 and plug 300 respectively in this embodiment conform to the USB-A standard, enabling a USB-A standard compatible plug to be connected to receptacle 200, and a USB-A standard compatible receptacle to be connected to plug 300.

First, receptacle 200 will be described.

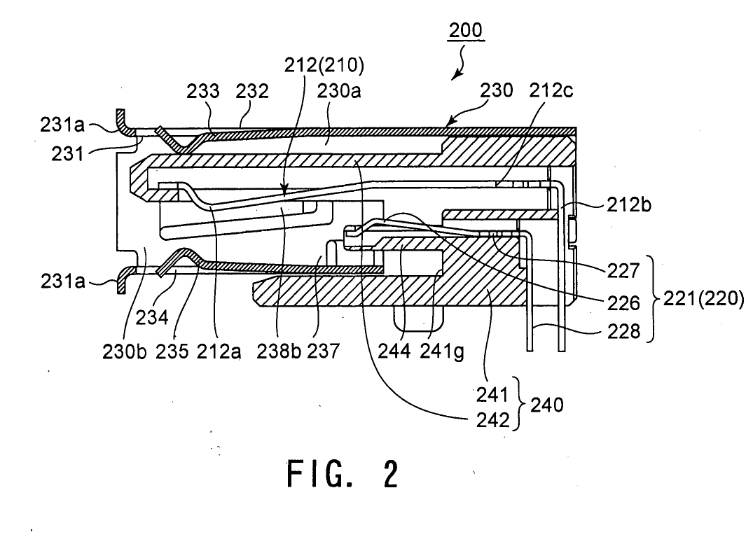

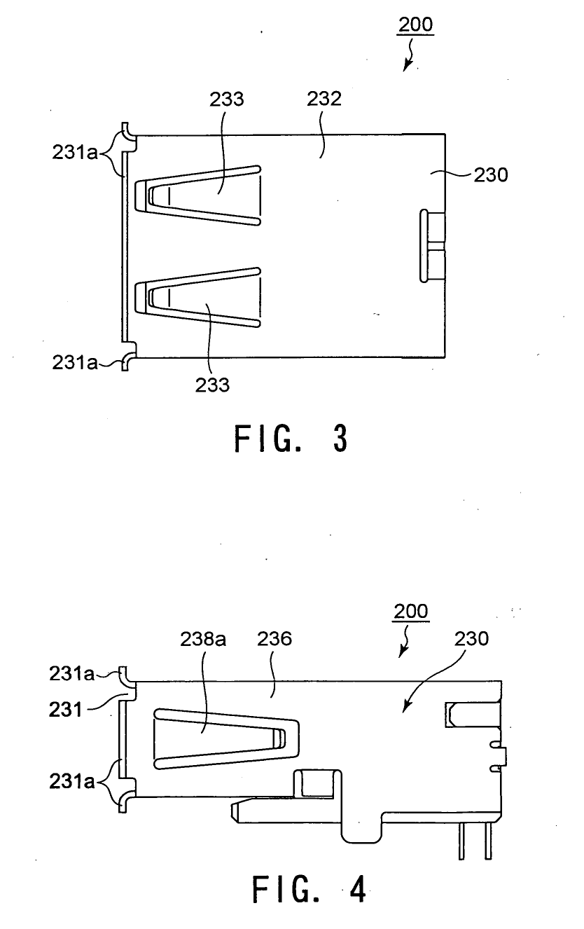

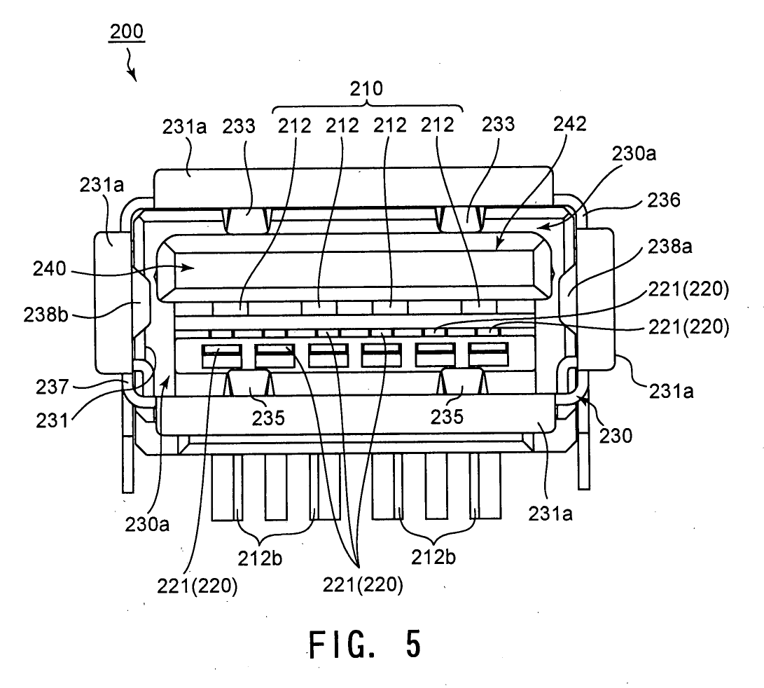

FIG. 2 is a schematic cross-sectional side view showing the configuration of a receptacle according to Embodiment 1 of the present invention, FIG. 3 is a plan view of this receptacle, FIG. 4 is a side view of this receptacle, and FIG. 5 is a front view of this receptacle.

Receptacle 200 shown in FIG. 2 through FIG. 5 has a shield case (shell) 230 that fits over an inserted plug 300, and a receptacle housing 240 that is covered by shield case 230 and holds USB terminal section 210 and other terminal section 220.

Receptacle 200 can be connected to plug 300, and is connected by means of a half-lock connection to a USB 2.0 standard based USB-A compatible plug.

In receptacle 200 shown in FIG. 2 through FIG. 5, shield case 230 is of electrically conductive material, and is here formed into a rectangular tubular shape, with an aperture section 231 that receives plug 300 formed at the front, by bending a metal sheet of copper alloy. Shield case 230 is provided with a continuous flange section 231a that projects circumferentially with respect to shield case 230 around the aperture at the front forming aperture section 231.

This shield case 230 is here formed into a rectangular tube shape that fits over a USB 2.0 standard based USB-A compatible plug.

In shield case 230, an upper latching lug 233 (see FIG. 1, FIG. 2, FIG. 3, and FIG. 5) projecting downward—that is, on the receiving section 230a side—is provided on an upper surface section 232 that partitions a receiving section 230a that receives a plug (see FIG. 1, FIG. 2, and FIG. 5) above.

As shown in FIG. 1, upper latching lug 233 is elastically deformed and engages in latch holes 333 (333a, 333b) in an upper surface section 332 of a shield case 330 of an inserted plug 300. That is to say, when plug 300 is inserted into receiving section 230a, this upper latching lug 233 presses plug 300 downward from the upper surface side of shield case 330 and engages in latch holes 333 (333a, 333b).

Also, as shown in FIG. 1 and FIG. 2, a lower latching lug 235 projecting upward—that is, on the receiving section 230a side—is provided on a lower surface section 234 that partitions receiving section 230a below.

Lower latching lug 235 is elastically deformed and engages in latch holes 335 (335a, 335b) in a lower surface section 334 of a shield case 330 of inserted plug 300. When plug 300 is inserted into receiving section 230a, this lower latching lug 235 presses plug 300 upward from the lower surface side of shield case 330.

In this way, when plug 300 is inserted into receiving section 230a, upper latching lug 233 and lower latching lug 235 engage in latch holes 333 and 335, and grip plug 300 by pressing it from above and below.

That is to say, upper latching lug 233 and lower latching lug 235 form a half-lock mechanism that half-locks inserted plug 300 to receptacle 200 itself.

Upper latching lug 233 and lower latching lug 235 are installed so as to correspond to latch holes formed in the upper and lower surfaces of a plug compatible with the USB-A standard (“USB-A standard compatible”). Therefore, when a USB-A standard compatible plug is inserted into shield case 230, engagement with the latch holes of the USB-A standard compatible plug occurs, and that USB-A standard compatible plug can also be half-locked.

Also, as shown in FIG. 2 through FIG. 5, side surfaces 236 and 237 that partition receiving section 230a in shield case 230 on the left and right have contacting sections 238a and 238b that project in mutually opposite directions—that is, toward receiving section 230a—and press upon and contact the inner side of plug 300 inserted into receiving section 230a. Through the contact of these contacting sections 238a and 238b, plug 300 inside receiving section 230a is gripped from the left and right, and electrical conductivity is established with electrically conductive shield case 330 of plug 300.

Upper latching lug 233, lower latching lug 235, and contacting sections 238a and 238b project progressively into receiving section 230a from the front aperture section 231 side to the rear section side in the inner peripheral surface of shield case 230, and are fitted so as to allow elastic deformation.

By means of this configuration, when plug 300 is inserted into receiving section 230a of receptacle 200, plug 300 is inserted without obstruction, and receptacle 200 holds plug 300 connected in a removable (half-locked) fashion.

Receptacle housing 240, covered peripherally by shield case 230, is fitted inside shield case 230 (see FIG. 1 and FIG. 2).

Attached to this receptacle housing 240 are USB terminal section 210 that is connected to USB terminal section 310 of plug 300, and other terminal section 220 that is connected to other terminal section 320 of plug 300 after USB terminal section 210 has been connected.

Receptacle housing 240 is made of a material with insulating properties such as PBT (Poly Butylene Terephthalate) resin, and has a portion cut out of the front of a prismatic body, forming a shape that accommodates a base section 342 of plug 300.

Specifically, as shown in FIG. 2, receptacle housing 240 has a prismatic base 241 located toward the rear inside shield case 230, and a projecting plate section 242 that overhangs at the front from one of the areas (here, the upper) resulting from the division into upper and lower areas at the front of base 241.

Base 241 secures receptacle housing 240 itself fitted inside shield case 230, and also secures USB terminal section 210 and other terminal section 220. On this base 241, projecting plate section 242 is provided integrally on the front surface.

Projecting plate section 242 is located along upper surface section 232 of shield case 230, and base section 342 inside shield case 330 of plug 300 (see FIG. 1 and FIG. 7) is accommodated between it and lower surface section 234 of shield case 230 below.

Projecting plate section 242 is fitted with USB terminal section 210 that makes contact with USB terminal section 310 on base section 342 inside the accommodating section at the front of projecting plate section 242 when plug 300 is inserted into receptacle 200.

USB terminal section 210 is composed of a plurality of connecting terminals comprising a VCC power supply terminal, GND power supply terminal, D+ data transmission terminal, and D− data transmission terminal, configured in the same way as in a conventional USB interface. The VCC power supply terminal, GND power supply terminal, D+ data transmission terminal, and D− data transmission terminal are also referred to as USB terminals.

USB terminal section 210 is here composed of a plurality of electrically conductive copper-alloy contact pins 212, each formed by bending a long plate-shaped member, and having a contact section 212a, a rear section 212b, and a center section 212c linking contact section 212a and rear section 212b.

Contact pins 212 (see FIG. 2) are arranged extending in the lengthwise direction of projecting plate section 242—that is, along the direction of insertion of plug 300. Front contact sections 212a of contact pins 212 located on the aperture section 231 side are free to move in an upward inner direction from a position projecting downward from the underside of projecting plate section 242.

Specifically, rear section 212b of a contact pin 212 is fixed in a vertically positioned state at the rear inside base 241, and the front part of center section 212c extending toward the front of receptacle 200 from the top of rear section 212b is inclined toward the inside of the receiving section.

Contact section 212a continuing to the front of center section 212c is positioned forward of the connecting part of other terminal section 220 inside base 241. The bottom of rear section 212b projects downward from the underside of base 241, and forms a lead connected to a board pattern when receptacle 200 is mounted on a board.

The plurality of contact pins 212 installed in this way are arranged in receptacle housing 240 parallel to each other at predetermined intervals. In projecting plate section 242, four contact pins 212 are here arranged in a similar way with respect to each other at predetermined intervals conforming to the USB-A standard (see FIG. 5).

In receptacle housing 240, other terminal section 220 is installed with the contact position further to the rear of receptacle 200 than the contact positions of contact pins 212 arranged as described above (see FIG. 1 and FIG. 2). That is to say, the contact position of other terminal section 220 is here further rearward than the contact position of a USB-A standard compatible plug inside shield case 230.

As shown in FIG. 1, other terminal section 220 is positioned further rearward—that is, on the rear section side—of a part of length A similar to the insertion length of a conventional USB standard plug in plug 300 inserted into shield case 230 from the rim of the aperture in shield case 230. The insertion length of a conventional USB standard plug means the length to which that plug is inserted into a corresponding USB receptacle when connected to that USB receptacle.

As shown in FIG. 5, other terminal section 220 is here composed of a plurality of contact pins 221 aligned in the horizontal direction.

As shown in FIG. 1, FIG. 2, and FIG. 5, these contact pins 221 are installed projecting forward from the other of the areas (here, the lower) resulting from the division into upper and lower areas at the front of base 241. The number of contact pins is here shown as six, but this is not a limitation, and any number may be used. For example, fewer than six may be used, or other terminal section 220 may be configured by horizontally aligning more than six contact pins, such as eight or ten. In this case, the number of other terminal sections 320 on the connected plug 300 side will, of course, be the same as the number of other terminal sections 220 of receptacle 200.

These contact pins 221 are formed by processing electrically conductive long plate-shaped members, and are arranged across base 241 and a plate-shaped projecting section 244 that projects forward from front surface 241g of base 241 and is located at the rear of projecting plate section 242.

Contact pins 221 each have a plate-shaped contact section 226 positioned along projecting plate section 242, a center section 227 continuing at the rear of contact section 226 and passing through base 241, and a rear section 228 leading downward from the rear of center section 227.

More specifically, contact section 226 is positioned projecting toward the front of receptacle 200 from front surface 241g of base 241. This contact section 226 is formed by bending a plate-shaped member located inside projecting section 244 either upward or downward (here, upward), and again bending the bent end in the opposite direction to that in which it was bent.

This contact section 226 is positioned with the bent part projecting above projecting section 244 that is located at the rear of projecting plate section 242, and, at this bent part, comes into contact with plate-shaped contact pins 326 (in this embodiment, also referred to as “connected terminals” but may also be referred to as “connecting terminals” when contact pins 221 are referred to as “connected terminals”) composing other terminal section 320 on the plug 300 side (see FIG. 1).

Center section 227 continuing at the rear of contact section 226 is fixed to base 241 below center section 212c of contact pin 212 (a USB terminal), and in a parallel state.

At the rear of center section 227, rear section 228 leading downward from the rear of rearward center section 227 in base 241 is provided continuously, and the lower end of this rear section 228 projects below base 241. The lower end of rear section 228 projecting below base 241 forms a lead that is connected to the circuitry of a board on which the receptacle is mounted.

By inserting plug 300 into this receptacle 200, USB terminal section 210 is connected to USB terminal section 310 of plug 300, and then other terminal section 220 is connected to other terminal section 320 of plug 300.

Thus, in receptacle 200, USB terminal section 210 and other terminal section 220 are located respectively in areas that are staggered in a direction orthogonal to the direction of insertion of plug 300 and aligned in the direction of insertion inside shield case 230.

That is to say, in receptacle housing 240, USB terminal section 210 and other terminal section 220 are arranged vertically, and their respective contact positions are staggered in the front-to-rear direction of receptacle 200—that is, in the direction of insertion of plug 300.

More specifically, the contact position of USB terminal section 210 is located at the front of receptacle housing 240—that is, at the front of shield case 230—and the contact position of other terminal section 220 is located at the rear of receptacle housing 240—that is, at the rear of shield case 230. Therefore, when plug 300 is inserted into receptacle 200, USB terminal section 210 is connected to plug-side USB terminal section 310 before other terminal section 220 is connected to plug-side other terminal section 320. Also, USB terminal section 210 does not come into contact with plug-side other terminal section 320 when connecting to USB terminal section 310 on the plug 300 side.

Next, a description will be given of plug 300 that is capable of transmitting a separate signal other than a USB signal via receptacle 200 by being connected to receptacle 200.

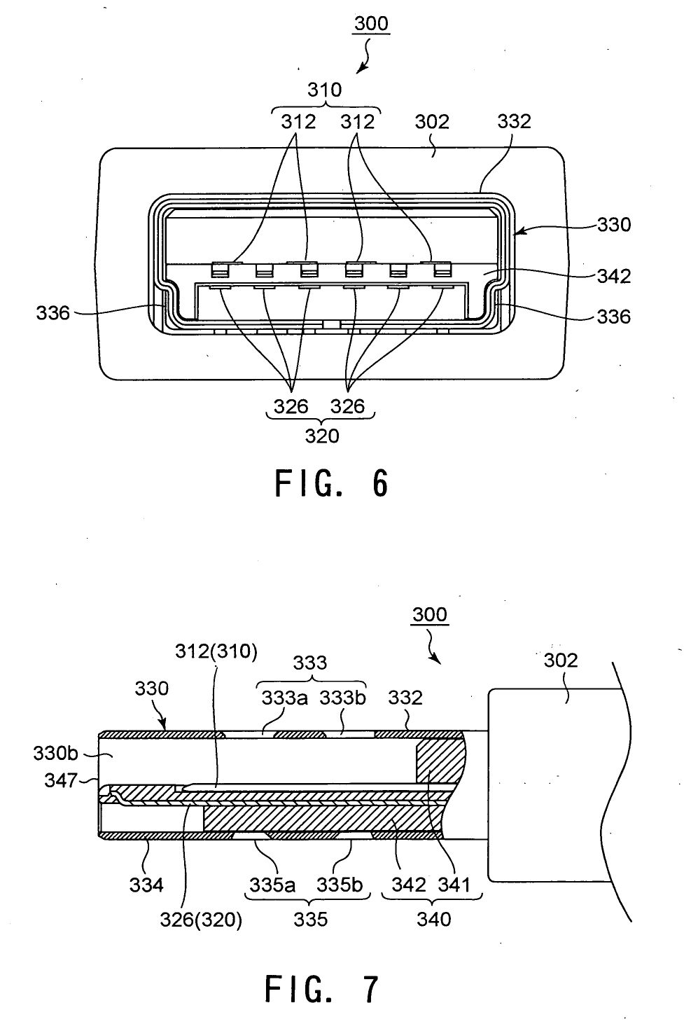

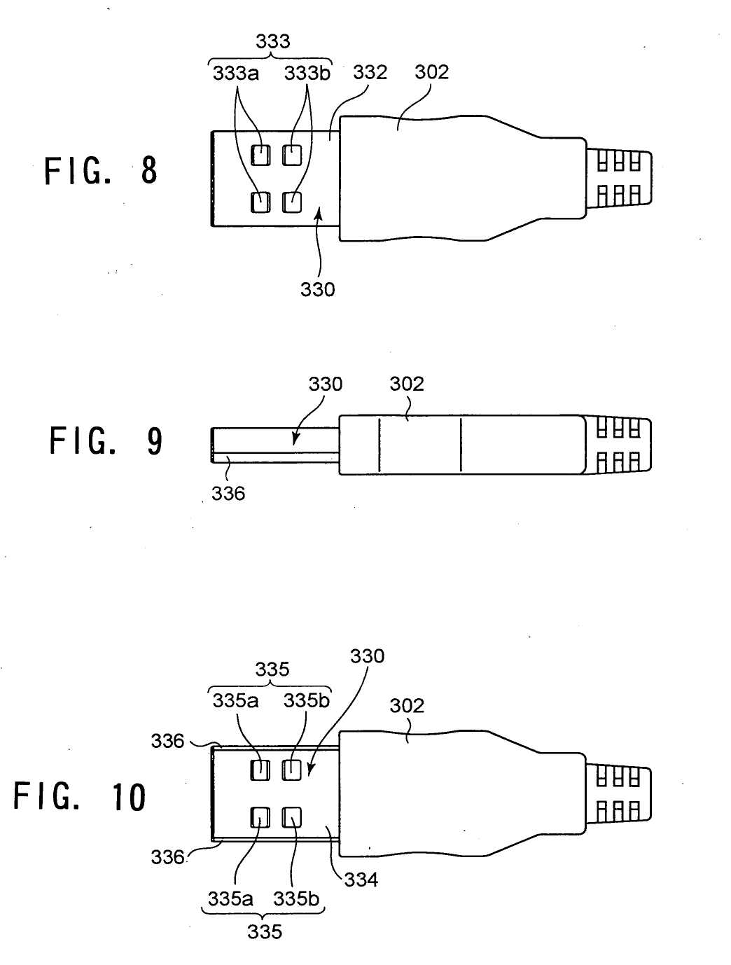

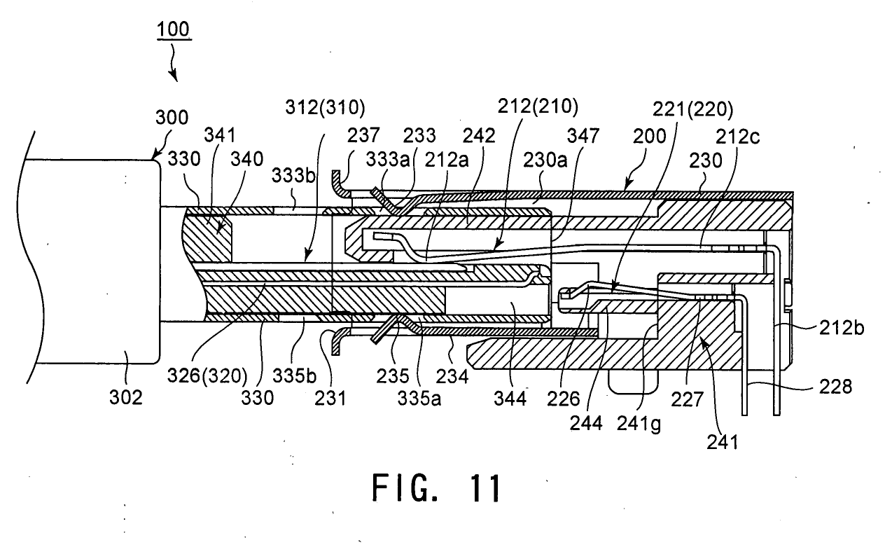

FIG. 6 is a front view of a plug according to Embodiment 1, FIG. 7 is a schematic cross-sectional side view showing the principal-part configuration of the plug, FIG. 8 is a plan view of the plug, FIG. 9 is a side view of the plug, and FIG. 10 is an underside view of the plug.

Through insertion of plug 300 shown in FIG. 1 and FIG. 6 through FIG. 10 into receptacle 200, USB terminal section 310 is connected to USB terminal section 210 of receptacle 200, and then other terminal section 320 is connected to other terminal section 220 of receptacle 200. When other terminal sections 220 and 320 are in the connected state, USB terminal sections 210 and 310 are connected.

Specifically, a plug case 302 is fitted to plug 300 at the rear, and circuitry (not shown) connected to USB terminal section 310 and other terminal section 320 is installed inside plug case 302.

Plug 300 has a shield case (shell) 330 that fits inside shield case 230 of receptacle 200, and a plug housing 340 that is covered by shield case 330 and is equipped with USB terminal section 310 and other terminal section 320 (see FIG. 6 and FIG. 7).

Shield case 330 is of electrically conductive material, and is here formed into a rectangular tubular shape by bending a metal sheet of copper alloy. The shape of the aperture of this shield case 330 is formed into the same shape as a USB 2.0 standard based USB-A compatible plug, and the length exposed outside plug case 302 is longer than for the shield case of a conventional USB-A compatible plug (corresponding to A in FIG. 1). For example, the aperture width (lateral width of the aperture viewed from the front) of rectangular-tube-shaped shield case 330 may be 12 mm for instance, and the vertical height of the aperture section (the vertical height of the aperture viewed from the front) may be 4.5 mm for instance. In this case, the projecting length of shield case 330 exposed outside plug case 302 may be made longer than that of a conventional USB standard compatible plug—for example, 15.8 mm.

As shown in FIG. 1, FIG. 7, FIG. 8, and FIG. 10, latch holes 333 and 335 in which upper and lower latching lugs 233 and 235 respectively engage are formed in upper and lower surface sections 332 and 334 of shield case 330.

As shown in FIG. 8 and FIG. 10, these latch holes 333 and 335 are formed in pairs in the direction of insertion for upper and lower latching lugs 233 and 235 respectively.

These latch holes 333 and 335 comprise USB connection latch holes 333a and 335a that maintain a USB connection, and other terminal connection latch holes 333b and 335b that maintain a connection of other terminal sections 220 and 320, when plug 300 is inserted into receptacle 200.

USB connection latch holes 333a and 335a are engaged at the position at which USB terminal sections 210 and 310 connect when plug 300 is inserted into receptacle 200, and plug 300 is half-locked in receptacle 200.

Other terminal connection latch holes 333b and 335b are engaged by upper and lower latching lugs 233 and 235 when plug 300 is inserted into receptacle 200 to the maximum extent—that is, when at the position at which other terminal sections 220 and 320 connect—and plug 300 is half-locked in receptacle 200.

Latch holes 333 formed in upper surface section 332 and latch holes 335 formed in lower surface section 334 are formed at mutually opposite positions.

In shield case 330, of the aperture rim sections defining latch holes 333 and 335 respectively, the front aperture rims face from the surface (outer surface) toward the rear surface (inner surface) and taper downward from the insertion direction side, as shown in FIG. 1, FIG. 2, and FIG. 7.

Upper and lower latching lugs 233 and 235 that engage in latch holes 333 and 335 can be engaged in latch holes 333 and 335 smoothly as plug 300 moves in the direction of insertion into receptacle 200.

As shown in FIG. 9, shield case 330 has a cut-out section extending lengthwise formed in a lower angular section 336 of both side sections, and, viewed from the front, the lower surface of shield case 330 is formed into a convex shape projecting downward (see FIG. 6). Inside this convex part, base section 342 is positioned on which is located other terminal section 320 that connects to other terminal section 220 of projecting section 244 inserted from the insertion aperture.

Base section 342 is plate-shaped, and within shield case 330, is located at a position that is opposite projecting plate section 242 of receptacle housing 240 when plug 300 is inserted into and mates with receptacle 200. Here, base section 342 is mounted on the upper surface of lower surface section 334 of shield case 330 inside shield case 330.

On its upper surface, base section 342 has USB terminal section 310 comprising USB connected terminals connected correspondingly to the USB terminals of USB terminal section 210 of receptacle 200.

USB terminal section 310 is composed of a plurality of USB connected terminals comprising a VCC power supply terminal, GND power supply terminal, D+ data transmission terminal, and D− data transmission terminal, configured in the same way as in a conventional USB interface.

USB terminal section 310 has a plurality of long, plate-shaped, electrically conductive contacts 312 as connected terminals, and these contacts 312 extend lengthwise inside plug 300 and are arranged parallel to each other at predetermined intervals (see FIG. 6). These predetermined intervals conform to the USB-A standard, and four contacts are here arranged in this way.

On the upper part of a rear section 310a of USB terminal section 310 is located an upper housing section 341 that forms with shield case 330 a receiving section 330b (see FIG. 6 and FIG. 7), into which projecting plate section 242 of receptacle 200 is inserted.

This upper housing section 341 is located at the front of projecting plate section 242 accommodated in receiving section 330b, and together with base section 342 forms plug housing 340.

Upper housing section 341 prevents receiving projecting plate section 242 from being inserted further than necessary into plug 300.

The external shape of base section 342 differs only in length compared with the external shape of the base section with which a conventional USB-A standard plug is provided, and the front view external shape has approximately the same dimensions.

Unlike a base section with which a conventional USB-A standard plug is provided, plug 300 of this embodiment is provided with other terminal section 320 inside. More specifically, in plug 300, a second accommodating section 344 that opens at the front insertion aperture and accommodates projecting section 244 of receptacle 200 is located inside base section 342, and when projecting section 244 is accommodated in this second accommodating section 344, other terminal section 320 connects to other terminal section 220 located in projecting section 244.

Other terminal section 320 comprises a plurality of connected terminals 326 that connect respectively to terminals (contact pins 221) of other terminal section 220 of receptacle 200 when plug 300 is mated with receptacle 200.

Connected terminals 326 may be configured in any way, as long as they connect to the terminals (here, contact pins 221) constituting other terminal section 220 of receptacle 200 when plug 300 is mated with receptacle 200.

Here, connected terminals 326 are electrically conductive long plate-shaped members, and, as shown in FIG. 1, FIG. 6, and FIG. 7, have their front ends exposed on the upper surface of second accommodating section 344 inside base section 342, and are arranged parallel to and separated from each other, extending in the direction of insertion of plug 300 (in the plug 300 lengthwise direction). The positions of these connected terminals 326 correspond to contact pins 221 of receptacle 200, and connected terminals 326 connect to corresponding contact pins 221, respectively.

In base section 342, connected terminals 326 connect to contact pins 221 at the front section located in an area forming the upper surface of second accommodating section 344.

That is to say, when projecting section 244 of receptacle 200 is inserted into second accommodating section 344 via the insertion aperture at the front of base section 342, connected terminals 326 connect to contact pins 221 by contact with contact sections 221a of contact pins 221 on projecting section 244.

In plug 300 of this embodiment, connected terminals 326 forming other terminal section 320 are located in an area that divides the upper surface of second accommodating section 344, but this is not a limitation, and connected terminals 326 may also be located at any position at the front of base section 342, such as an area that partitions the lower surface of second accommodating section 344.

This plug 300, being provided with other terminal section 320, has a proportionally greater insertion length for insertion into a receptacle than a conventional USB-A standard compatible plug—that is, the length of shield case exposed outside plug case 302 is proportionally greater. For example, if the projecting length of shield case 330 exposed outside plug case 302 is 15.8 mm, it is desirable for the length from the front of shield case 330 to the front edges of USB connection latch holes 333a and 335a to be made 5.16 mm, and for the length from the front to the front edges of other terminal connection latch holes 333b and 335b to be made 8.96 mm.

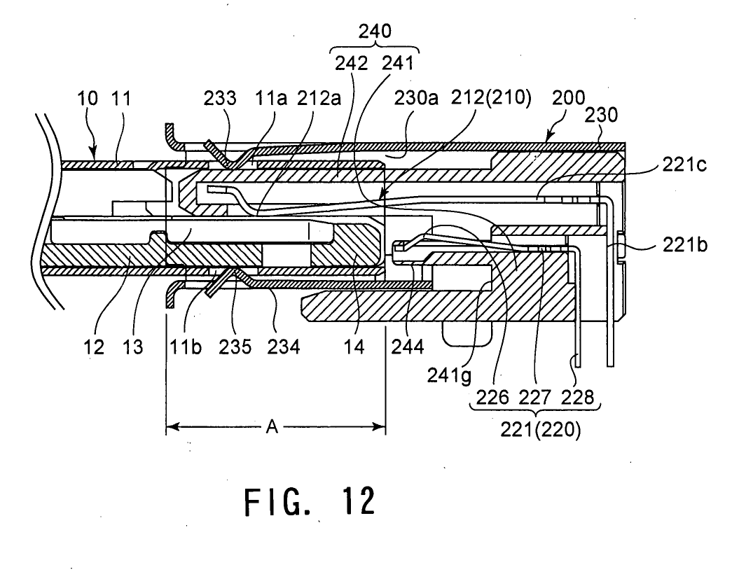

A connection operation of receptacle 200 and plug 300 configured in this way with connector apparatus 100 having both will now be described, with reference mainly to FIG. 1, FIG. 2, FIG. 7, and FIG. 11.

When connecting plug 300 to receptacle 200, plug 300 is inserted from aperture section 231 of receptacle 200 (see FIG. 2). At this time, flange section 231 a formed on the rim of the aperture of shield case 230 in receptacle 200 guides shield case 330 of plug 300 into shield case 230.

Shield case 330 is progressively fitted inside shield case 230 of receptacle 200, and when plug 300 is further inserted into shield case 230, USB terminal section 210 of receptacle 200 first comes into contact with USB terminal section 310 of plug 300.

Specifically, USB terminals (contact pins) 212 of USB terminal section 210 slide over the surfaces of the corresponding USB terminal section 310 USB terminals in the direction of extraction of plug 300.

Then, when contact pins (USB terminals) 212 reach a predetermined contact position on USB terminal section 310, upper and lower latching lugs 233 and 235 of shield case 230 engage in latch holes 333a and 335a of shield case 330, and plug 300 itself is half-locked. By this means, receptacle 200 and plug 300 are maintained in a USB-connected state.

FIG. 11 is a schematic cross-sectional side view showing a state in which only USB connection has been performed in a connector apparatus according to Embodiment 1 of the present invention.

As shown in FIG. 11, when upper and lower latching lugs 233 and 235 of shield case 230 are engaged respectively in latch holes 333a and 335a of shield case 330, only USB terminal sections 210 and 310 of receptacle 200 and plug 300 respectively are in mutual contact. That is to say, with connector apparatus 100, a first-stage connection state in which plug 300 is inserted into receptacle 200 and initially half-locked is conveyed intuitively to the user as a USB connection state.

When plug 300 is further inserted into receptacle 200, the upper and lower latching lugs are released from the latch holes, and slide along the upper surface of shield case 330 in the direction of extraction.

Inside shield case 230, base section 342 is further inserted into the lower space of projecting plate section 242 of receptacle housing 240 (inside receiving section 230b shown in FIG. 2). Then projecting section 244 on which contact sections 221a of contact pins 221 constituting other terminal section 220 of receptacle 200 are located is inserted into the insertion aperture provided in front surface 347 of base section 342.

Next, projecting section 244 inserted from the insertion aperture is inserted into second accommodating section 344 of base section 342—that is, contact sections 226 of contact pins 221 are inserted into second accommodating section 344 of base section 342.

Inserted contact sections 226, since they are bent toward contact pins 326 on the upper surface side of second accommodating section 344 above projecting section 244 inside second accommodating section 344 of base section 342, slide over contact pins 326 in the direction of extraction while pressing against their surfaces. That is to say, contact sections 226 move in a state of connection to contact pins 326.

Then, on reaching a predetermined position, upper and lower latching lugs 233 and 235 of shield case 230 engage in latch holes 333b and 335b formed in the upper and lower surfaces respectively of shield case 330 at the rear of plug 300, and half-lock plug 300. The predetermined position mentioned here is a connection position for a separate signal other than a USB signal located to the rear of the USB connection position inside shield case 230.

In this kind of second-stage half-lock state in connector apparatus 100, plug 300 and receptacle 200 are maintained in a state in which USB terminal sections 210 and 310 and other terminal sections 220 and 320 are connected (see FIG. 1).

Therefore, when plug 300 is inserted further into receptacle 200 from the half-locked first-stage connection state, the half-lock state is released, and then plug 300 is half-locked again, and the fact that the second-stage connection state has been established can be conveyed intuitively to the user.

Thus, with connector apparatus 100, when plug 300 is inserted into receptacle 200, USB connection and connection of a separate signal other than a USB signal can be performed by means of a two-stage connection process.

That is to say, when plug 300 is inserted into and mates with receptacle 200, latch holes (first latched sections) 333a and 335a are engaged in a releasable fashion by upper and lower latching lugs (latching sections) 233 and 235 of receptacle 200 at a position at which USB terminal section (first terminal section) 310 and USB terminal section (first connected terminal section) 210 connect. Also, latch holes (second latched sections) 333b and 335b are engaged in a releasable fashion by upper and lower latching lugs 233 and 235 at a position at which USB terminal section 310 and other terminal section 320 connect respectively to USB terminal section 210 and other terminal section 220.

By this means, when plug 300 is inserted into and mates with receptacle 200, and upper and lower latching lugs 233 and 235 slide along the upper surface of shield case 332 of plug 300 and engage in latch holes 333a and 335a, USB terminal sections 210 and 310 are connected.

Also, when plug 300 is inserted more deeply into receptacle 200, upper and lower latching lugs 233 and 235 are disengaged from latch holes 333a and 335a, slide along the upper surface of shield case 332, and engage in latch holes 333b and 335b. At this time, USB terminal section 310 and other terminal section 320 become connected to USB terminal section 210 and other terminal section 220 respectively.

Therefore, when a user inserts plug 300 into receptacle 200, the user can be made aware intuitively of the connection of USB terminal sections 210 and 310, and the connection of USB terminal sections 210 and 310 and other terminal sections 220 and 320, by the engagement of upper and lower latching lugs 233 and 235 in latch holes 333a, 335a, 333b, and 335b.

In connector apparatus 100 of this embodiment, receptacle 200 mates with an inserted plug 300 and is connected to that plug 300. This receptacle 200 is provided with USB terminal section 210 and other terminal section 220 that are connected respectively to USB terminal section 310 and other terminal section 320 of plug 300. The respective contact positions of USB terminal section 210 and other terminal section 220 are staggered in the direction of insertion of 300 and vertically.

Also, the contact position of other terminal section 220 is located further on the plug 300 insertion direction side than the contact position of USB terminal section 210, and the contact positions of USB terminal section 210 and other terminal section 220 are located respectively in upper and lower areas in the plug 300 mating area when viewed from the insertion direction side.

Meanwhile, plug 300 is provided with USB terminal section 310 and other terminal section 320 that are connected respectively to USB terminal section 210 and other terminal section 220 of receptacle 200.

The contact positions of USB terminal section 310 and other terminal section 320 are staggered in the direction of insertion of plug 300 and vertically, and the contact position of USB terminal section 310 is located further on the plug insertion direction side than the contact position of other terminal section 320.

By this means, when plug 300 is inserted into and mates with receptacle 200, USB terminal section 210 of the receptacle connects to USB terminal section 310 without other terminal section 220 of receptacle 200 coming into contact with USB terminal section 310 of plug 300. Following this, other terminal section 220 of receptacle 200 connects to other terminal section 320 without USB terminal section 210 of receptacle 200 and other terminal section 320 being brought into contact.

Thus, with connector apparatus 100 of this embodiment, simply connecting plug 300 to receptacle 200 enables a USB signal to be transmitted through the connection of USB terminal sections 210 and 310, and also enables a separate signal other than a USB signal to be transmitted through the connection of other terminal sections 220 and 320.

Also, when receptacle 200 and plug 300 are connected, terminals (contact pins 212, contacts 312) transmitting a USB signal can both be securely connected without coming into contact with terminals (connected terminals 326, contact pins 221) transmitting a separate signal other than a USB signal.

Furthermore, receptacle 200 also allows the insertion and connection of a conventional USB-A standard plug. That is to say, shield case 230 is formed as compatible with USB-A based on the USB standard. By this means, it is possible for a plug compatible with the USB-A standard to be fitted inside receiving section 230a of shield case 230, and for a USB-A compatible plug to be inserted into this receiving section 230a.

Moreover, receptacle 200 also allows the insertion of a conventional USB standard plug, and plug 300 can also be inserted into a socket compatible with a well-known conventional USB standard plug.

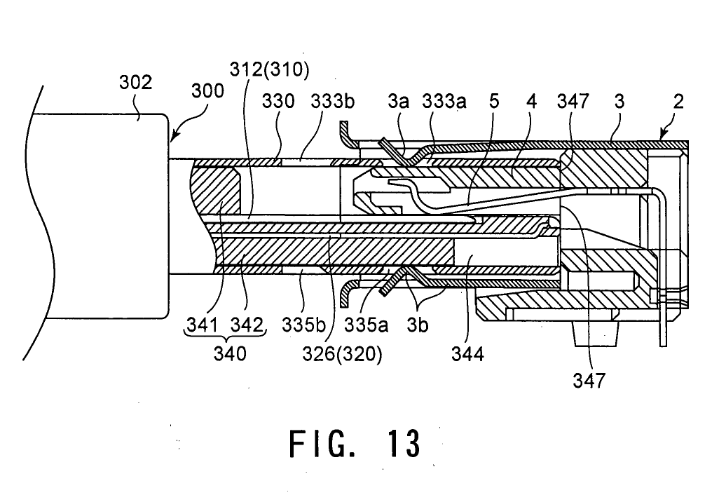

A case in which a conventional USB standard plug (hereinafter referred to as “a conventional plug”) is connected to receptacle 200 will now be described with reference to FIG. 12.

FIG. 12 is a schematic cross-sectional side view showing a state in which a conventional plug that is a conventional USB standard plug has been inserted into a receptacle in a connector apparatus according to Embodiment 1 of the present invention.

The aperture shape of shield case 230 of receptacle 200 shown in FIG. 12 conforms to the shape of a conventional plug 10, as stated above, and allows the insertion of conventional plug 10. Also, USB terminal section 210 of receptacle 200 is composed of a plurality of connecting terminals comprising a VCC power supply terminal, GND power supply terminal, D+data transmission terminal, and D− data transmission terminal, configured in the same way as in a conventional USB interface to which conventional plug 10 is connected.

When a shield case 11 of conventional plug 10 is inserted into this receptacle 200, shield case 11 fits inside shield case 230 of receptacle 200 and moves forward into shield case 230. Then, when upper latching lug 233 and lower latching lug 235 of shield case 230 engage in latch holes 11a and 11b of shield case 11, USB terminal section 210 connects to a USB terminal section 13 exposed on the upper surface of a base section 14 of a plug housing 12 covered by shield case 11 in conventional plug 10.

That is to say, when conventional plug 10 is inserted into receptacle 200, conventional plug 10 is USB-connected at a first-stage half-lock position in receptacle 200.

In receptacle housing 240, the contact position of other terminal section 220 is further to the rear of receptacle 200 than the contact position of contact pins 212—that is, to the rear of the contact position of a USB-A standard compatible plug. In FIG. 12, other terminal section 220 is located to the rear of insertion length A of conventional plug 10 with respect to receptacle 200 inside shield case 230.

Therefore, as shown in FIG. 12, when receptacle 200 is USB-connected to conventional plug 10 at the first-stage position, other terminal section 220 itself is not interfered with by conventional plug 10.

Also, inside receptacle 200, projecting plate section 242 has its movement toward conventional plug 10 restrained by the rear surface inside shield case 11 in conventional plug 10. Therefore, conventional plug 10 is not inserted further than necessary into receptacle 200. That is to say, interference with USB terminal section 210 of receptacle 200 by conventional plug 10 can be prevented regardless of the extent of insertion of conventional plug 10 into receptacle 200.

Thus, receptacle 200 enables transmission and reception of a USB signal and a separate signal other than a USB signal, such as handled by plug 300, to be performed, and also enables USB standard conventional plug 10 to be inserted and the same kind of USB signal transmission and reception as with a conventional USB receptacle to be performed via conventional plug 10.

Also, in shield case 230, upper and lower latching lugs 233 and 235 are provided that correspond to latch holes formed in the upper and lower surfaces of the shield case of a USB-A standard compatible plug. Thus, when a USB-A standard compatible plug is inserted into shield case 230, upper and lower latching lugs 233 and 235 engage in the latch holes of the USB-A standard compatible plug, and that USB-A standard compatible plug is also half-locked in a USB-connected state. By this means, receptacle 200 of this embodiment can prevent a USB-A standard compatible plug from being inserted further than necessary.

On the other hand, plug 300 of this embodiment can be inserted into a socket for a conventional USB standard plug.

FIG. 13 is a schematic cross-sectional side view showing a state in which a plug according to Embodiment 1 of the present invention has been connected to a conventional USB socket.

USB socket 2 shown in FIG. 13 has a metal case 3 that fits over the case layer of a conventional USB-A standard compatible plug, and a gripping plate section 4 (projecting plate section) whose periphery is covered by case 3, and that is inserted above the base section of the USB plug and is gripped between case 3 and the base section.

On gripping plate section (projecting plate section) 4, contact pins 5 are provided whose contact part projects downward from the underside and that are connected to connecting terminals of a conventional USB-A standard compatible plug (for example, conventional plug 10 shown in FIG. 12) when the conventional plug is connected.

In contrast, compared with a conventional USB-A standard compatible plug (for example, conventional plug 10 shown in FIG. 12), plug 300 of this embodiment is formed in almost the same way in terms of external shape, USB terminal section location, and so forth, differing only in length and the internal configuration of the base section.

Therefore, as shown in FIG. 13, when plug 300 is inserted into conventional USB-A standard USB socket 2, upper and lower latching lugs 3a and 3b of case 3 are engaged in latch holes 333a and 335a. By this means, USB signal transmission can be performed when connected terminals (contacts) 312 of USB terminal section 310 are connected to contact pins 5—that is, when plug 300 is half-locked in a state of USB connection to USB socket 2.

With connector apparatus 100 according to this embodiment, the plurality of terminals in other terminal section 220 of receptacle 200 are assumed to be plate-shaped contact pins 221, and the plurality of terminals composing other terminal section 320 in plug 300 are assumed to be plate-shaped connected terminals 326, but these are not limitations.

Other terminal sections 220 and 320 of receptacle 200 and plug 300 may be of any configuration as long as they are configured so as to be connected after USB terminal sections 210 and 310 are connected.

### Embodiment 2

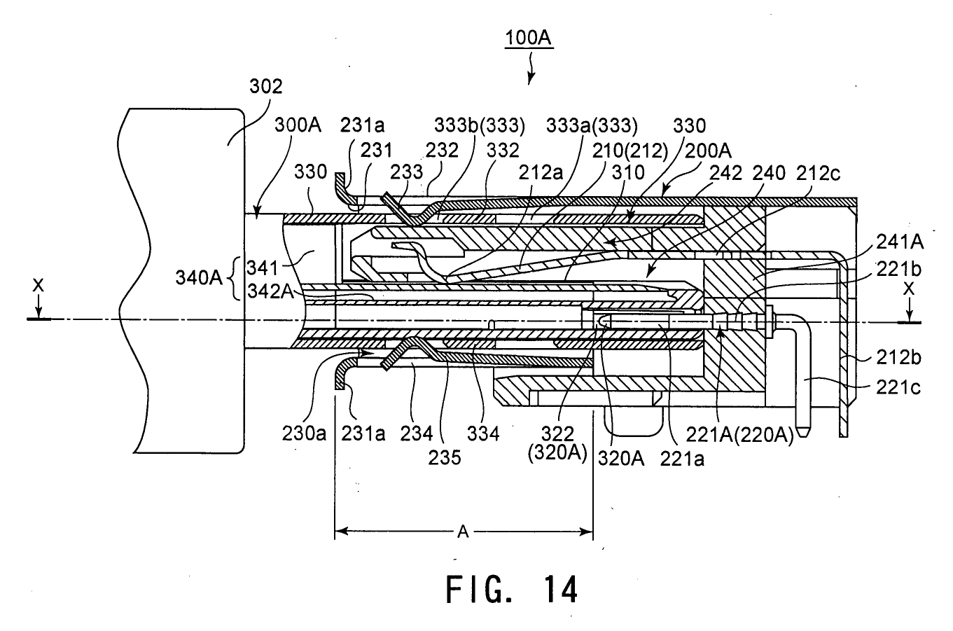

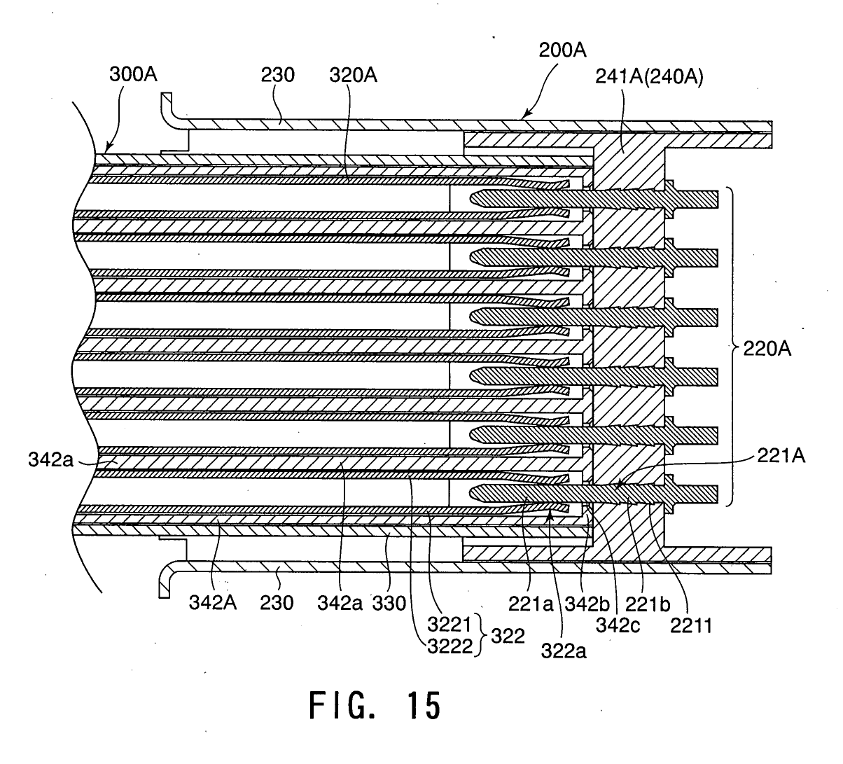

FIG. 14 is a schematic cross-sectional side view of a connector apparatus showing a state in which a receptacle and plug according to Embodiment 2 of the present invention have been mated, and FIG. 15 is a cross-sectional view through line X-X shown in FIG. 14.

Compared with connector apparatus 100 according to Embodiment 1 shown in FIG. 1, this connector apparatus 100A differs only in the configuration of the other connecting terminal sections (other terminal sections), with the remainder of the configuration being the same. Therefore, in the following description, identical configuration elements are assigned the same reference codes, and descriptions thereof are omitted.

In connector apparatus 100A, the shapes of other terminal sections 220 and 320 of receptacle 200 and plug 300 connected together in connector apparatus 100 have been changed, and the respective connection structures have been changed. Specifically, in connector apparatus 100A, the mutually contacting plate-shaped contact pins 221 and connected terminals 326 are replaced by rod-shaped contact pins 221A and gripping terminals 322.

That is to say, connector apparatus 100A shown in FIG. 14 is provided with a receptacle 200A, and a plug 300A that is inserted into receptacle 200A and is thereby mated therewith and forms a USB connection with receptacle 200A, and is capable of transmitting a signal different from a USB signal.

With connector apparatus 100A shown in FIG. 14, when plug 300A is mated with receptacle 200A, USB terminal sections 210 and 310 and other terminal sections 220A and 320A that transmit a different signal from the signal transmitted by USB terminal sections 210 and 310 of receptacle 200A and plug 300A are connected.

Receptacle 200A has a shield case (shell) 230 that fits over an inserted plug 300A, and a receptacle housing 240A that is covered by shield case 230 and holds USB terminal section 210 and other terminal section 220A. Shield case 230 is configured in the same way as that of receptacle 200 of Embodiment 1, being formed into a shape that fits over a USB 2.0 standard based USB-A compatible plug. That is to say, when plug 300A is inserted into receiving section 230a of receptacle 200A, plug 300A is inserted without obstruction, and receptacle 200A holds plug 300A connected in a removable (half-locked) fashion.

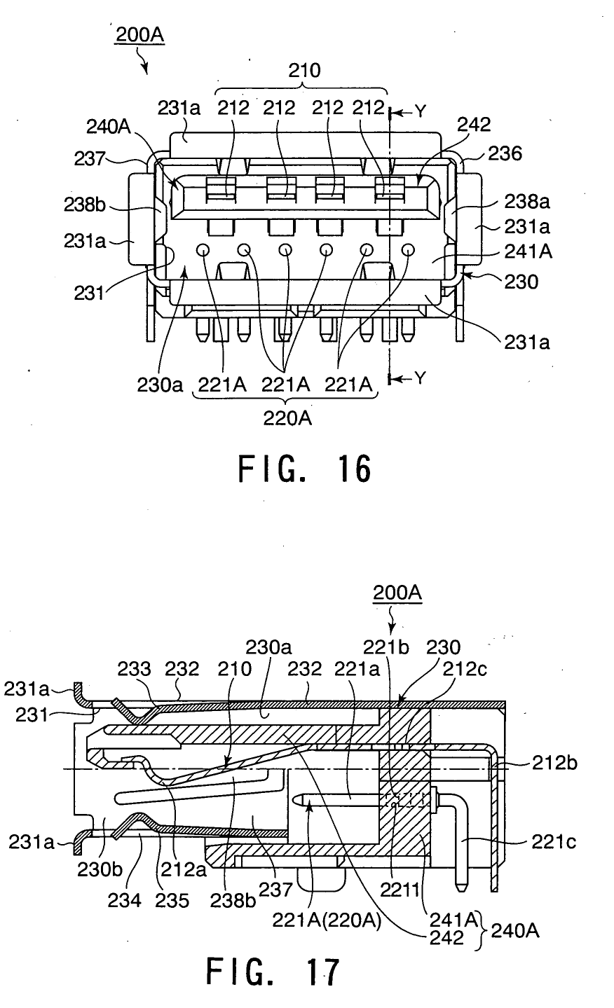

FIG. 16 is a front view of a receptacle according to Embodiment 2 of the present invention, and FIG. 17 is a cross-sectional view through line Y-Y shown in FIG. 16.

Receptacle housing 240A covered by shield case 230 has USB terminal section 210 that is connected to USB terminal section 310 of plug 300A, and other connecting terminal section 220A that is connected to other connecting terminal section 320A after USB terminal section 210 has been connected.

As in the case of receptacle housing 240, receptacle housing 240A is made of a material with insulating properties such as PBT (Poly Butylene Terephthalate) resin. Here, receptacle housing 240A uses a resin with insulating properties, and has a portion cut out of the front of a prismatic body, forming a shape that accommodates a base section 342A of plug 300A.

Specifically, receptacle housing 240A has a base 241A located toward the rear inside shield case 230, and a projecting plate section 242 that overhangs at the front from one of the areas (here, the upper) resulting from the division into upper and lower areas at the front of base 241A.

Projecting plate section 242 is located along upper surface section 232 of shield case 230, and below, contact section 212a of a contact pin 212 constituting USB terminal section 210 makes contact with USB terminal section 310 of base section 342A of plug 300A. Contact pins 212 are aligned side-by-side in the horizontal direction in receptacle housing 240A, separated by an interval conforming to the USB-A standard. Contact pins 212 located on projecting plate section 242 have the same kind of operational effect as in Embodiment 1, and a description thereof is omitted here.

In receptacle housing 240A, other terminal section 220A is installed with the contact position further to the rear of receptacle 200A than the contact positions of contact pins 212—that is, further rearward than the contact position of a USB-A standard compatible plug.

Other terminal section 220A, whose configuration differs from that in receptacle 200, will now be described in detail.

Other terminal section 220A is composed of a plurality of contact pins 221A whose shape differs from that in other terminal section 220.

As shown in FIG. 14 and FIG. 17, these contact pins 221A are installed projecting forward from one of the areas (here, the lower) resulting from the division into upper and lower areas at the front surface 241g of base 241A formed in virtually the same way as base 241.

The number of contact pins is here shown as six, but this is not a limitation, and any number may be used. For example, fewer than six may be used, or other terminal section 220A may be configured by horizontally aligning more than six contact pins, such as eight or ten. In this case, the number of other terminal sections 320 on the connected plug 300A side will, of course, be the same as the number of other terminal sections 220A of receptacle 200A.

In the same way as contact pins 221, contact pins 221A are installed projecting forward from the other of the areas (here, the lower) resulting from the division into upper and lower areas at the front of base 241A. Here, contact pins 221A are located in the same kind of positions as contact pins 221 in Embodiment 1.

Here, contact pins 221A are installed with their respective contact sections 221a projecting forward from front surface 241g of base 241A formed in the same way as base 241, and aligned in the horizontal direction in the lower part inside shield case 230.

The contact positions of contact pins 221A are located at the rear of receptacle housing 240—that is, at the rear of shield case 230—as opposed to USB terminal section 210 in which the contact positions are located at the front of shield case 230.

In receptacle 200A of Embodiment 2, contact pins 221A are formed by processing electrically conductive members. Here, contact pins 221A are formed by processing rod-shaped members of copper alloy.

Specifically, as shown in FIG. 1, FIG. 2, and FIG. 5, contact pins 212A are each composed of a rod-shaped contact section 221a positioned parallel to projecting plate section 242 and at the rear of the projecting plate section, a rod-shaped center section 221b continuing at the rear of contact section 221a, and a rod-shaped rear section 221c leading downward from the rear section of center section 221b.

As shown in FIG. 14 and FIG. 17, center section 221b has a lug 2211 that engages in base 241 formed on its periphery, and this lug 2211 prevents contact pins 221A from coming out of base 241A in a rearward direction. Also, center section 221b is fixed in base 241A below and parallel to the rear section of center section 212c (see FIG. 14 and FIG. 17).

The end of rear section 221c opposite the end that continues from center section 221b projects below base 241A and forms a lead that is connected to the circuitry of a board on which the receptacle is mounted.

By inserting plug 300A into receptacle 200A configured in this way, USB terminal section 210 (comprising contact pins 212) is connected to USB terminal section 310 of plug 300A, and then other terminal section 220A (comprising contact pins 221A) is connected to other terminal section 320A (comprising gripping terminals 322) of plug 300A.

Thus, with receptacle 200, in receptacle housing 240A inside shield case 230, USB terminal section 210 and other terminal section 220A are located above and below, and their respective contact positions are staggered in the front-to-rear direction of receptacle 200A—that is, in the direction of insertion of plug 300A.

A description will now be given of plug 300A that is connected to receptacle 200A and is capable of transmitting a separate signal other than a USB signal via receptacle 200A.

As with plug 300, plug 300A has plug case 302 fitted at the rear, and circuitry (not shown) connected to internal terminal sections 310 and 320A is installed inside plug case 302.

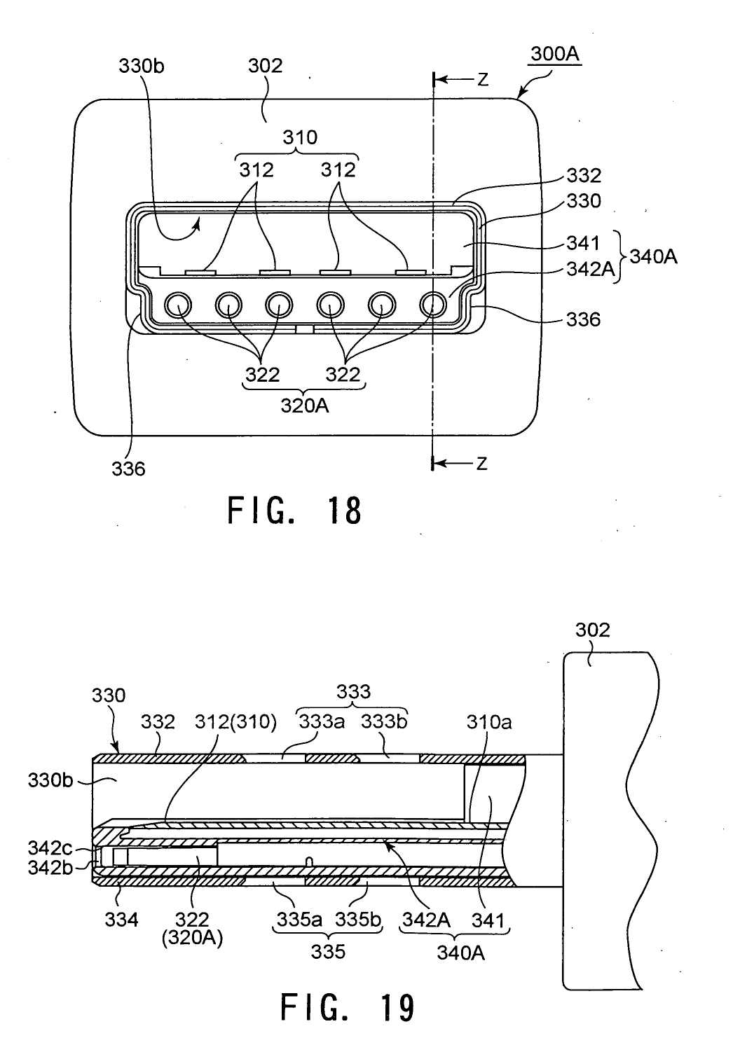

FIG. 18 is a front view of a plug according to Embodiment 2 of the present invention, and FIG. 19 is a cross-sectional view through line Z-Z shown in FIG. 18.

Plug 300A has a plug housing 340A that is covered by shield case (shell) 330 that fits inside shield case 230 of receptacle 200A, and is equipped with base section 342A on which USB terminal section 310 and other terminal section 320A are located. The configuration of shield case 330—that is, the configuration of latch holes 333 and 335 and so forth—is the same as in Embodiment 1, and therefore a description thereof is omitted here.

As with plug 300, base section 342A inside shield case 330 is provided in an area that is positioned at the cut-out section of receptacle housing 240A when plug 300A is inserted into and mates with receptacle 200A. Here, base section 342A is mounted on the upper surface of lower surface section 334 of shield case 330 inside shield case 330.

When plug 300A shown in FIG. 14, FIG. 15, FIG. 18, and FIG. 19 is inserted into receptacle 200A, USB terminal section 310 is connected to USB terminal section 210 of receptacle 200A, and then other terminal section 320A is connected to other terminal section 220A of receptacle 200A.

Within shield case 330, base section 342A is located at a position that is opposite projecting plate section 242 of receptacle housing 240A when plug 300A is inserted into and mates with receptacle 200A. Here, base section 342A is mounted on the upper surface of lower surface section 334 of shield case 330 inside shield case 330.

In the same way as base section 342, on its upper surface, base section 342A has USB terminal section 310 comprising USB connected terminals connected correspondingly to the USB terminals of USB terminal section 210 of receptacle 200A.

USB terminal section 310 is composed of a plurality of USB connected terminals comprising a VCC power supply terminal, GND power supply terminal, D+data transmission terminal, and D− data transmission terminal, configured in the same way as in a conventional USB interface.

USB terminal section 310 has a plurality of long, plate-shaped, electrically conductive contacts 312 as connected terminals, and these contacts 312 extend lengthwise inside plug 300A and are arranged parallel to each other at predetermined intervals (see FIG. 18). These predetermined intervals conform to the USB-A standard, and four contacts are here arranged in this way.

On the upper part of a rear section 310a of USB terminal section 310 is located an upper housing section 341 (as in the case of plug 300) that forms with shield case 330a receiving section 330b (see FIG. 18 and FIG. 19), into which projecting plate section 242 of receptacle 200A is inserted.

Unlike a base section with which a conventional USB-A standard plug is provided, plug 300A of this embodiment is provided with other terminal section 320A inside.

Other terminal section 320A comprises a plurality of connected terminals (here, gripping terminals 322) that connect respectively to terminals (contact pins 221A) of other terminal section 220A of receptacle 200A when plug 300A is mated with receptacle 200A.

Connected terminals 322 may be configured in any way, as long as they connect to the terminals (here, contact pins 221A) constituting other terminal section 220A of receptacle 200A when plug 300A is mated with receptacle 200A.

Here, as shown in FIG. 15, connected terminals 322 are configured by means of gripping terminals 322 that grip contact pins 221 of other terminal section 220 by means of two plate sections located opposite each other.

Gripping terminals 322 shown in FIG. 15 are each formed of two long electrically conductive plates—here long copper-alloy plates 3221 and 3222—positioned opposite each other in the horizontal direction. These plates 3221 and 3222 are connected at the rear end, and narrow at the front end to form a contact section 322a.

These gripping terminals 322 are arranged in space inside base section 342, partitioned by partitioning walls 342a aligned in the lengthwise direction, and are not in contact with each other.

The spaces partitioned by these contact sections 322a communicate with insertion apertures 342c formed in front surface 342b of base section 342, and contact pins 221A of receptacle 200A are inserted into these insertion apertures 342c.

That is to say, gripping terminals 322 are connected to contact pins 221A by gripping by contact sections 322a of contact sections 221a of contact pins 221A of receptacle 200A inserted via insertion apertures 342c.

A connection operation of receptacle 200A and plug 300A in connector apparatus 100A configured in this way will now be described.

With connector apparatus 10A, as with connector apparatus 100, when connecting plug 300A to receptacle 200A, plug 300A is inserted from the aperture section of receptacle 200A. At this time, flange section 231a formed on the rim of the aperture of shield case 230 in receptacle 200A guides shield case 330 of plug 300A into shield case 230.

Shield case 330 is progressively fitted inside shield case 230 of receptacle 200A, and when plug 300A is further inserted into shield case 230, USB terminal section 210 of receptacle 200A comes into contact with USB terminal section 310 of plug 300A at the contact position.

Specifically, USB terminals (contact pins) 212 of USB terminal section 210 make contact by sliding over the surfaces of the corresponding USB terminal section 310 USB terminals in the direction of extraction of plug 300A.

Then, when contact pins (USB terminals) 212 reach a predetermined position on USB terminal section 310, upper and lower latching lugs 233 and 235 of shield case 230 engage in latch holes 333a and 335a of shield case 330, and plug 300A itself is half-locked. By this means, plug 300A and receptacle 200A are maintained in a USB-connected state.

As with the relationship between receptacle 200 and plug 300 in Embodiment 1, when plug 300A is inserted into receptacle 200A and upper and lower latching lugs 233 and 235 of shield case 230 are engaged respectively in latch holes 333a and 335a of shield case 330, only USB terminal sections 210 and 310 of receptacle 200A and plug 300A respectively are in mutual contact. That is to say, with connector apparatus 100A, a first-stage connection state in which plug 300A is inserted into receptacle 200A and initially half-locked is conveyed intuitively to the user as a USB connection state.

When plug 300A is further inserted into receptacle 200A, upper and lower latching lugs 233 and 235 are released from latch holes 333a and 335a, and slide along the upper surface of shield case 330 in the direction of extraction.

Inside shield case 230, base section 342 is further inserted into receiving section 230a of receptacle housing 240A [to be precise, the lower space of projecting plate section 242 of receptacle housing 240 (receiving section 230b shown in FIG. 17)], and contact sections 221a of contact pins 221A constituting other terminal section 220A of receptacle 200A are inserted into the insertion aperture provided at the front of base section 342A on front surface 347.

Inserted contact sections 221a are connected to gripping terminals 322 by being gripped by contact sections 322a of gripping terminals 322 inside base section 342A. When contact pins 221A and gripping terminals 322 are connected, contact pins 212 of USB terminal section 210 and contacts 312 of USB terminal section 310 become mutually connected.

At this time, upper and lower latching lugs 233 and 235 of shield case 230 engage respectively in latch holes 333b and 335b formed in the upper and lower surfaces respectively of shield case 330 at the rear of plug 300A, and half-lock plug 300A to shield case 230.

By this means, receptacle 200A and plug 300A are maintained in a state in which USB terminal sections 210 and 310 and other terminal sections 220A and 320A are connected.

That is to say, when plug 300A is inserted into and mates with receptacle 200A, latch holes (first latched sections) 333a and 335a are engaged in a releasable fashion by upper and lower latching lugs (latching sections) 233 and 235 of receptacle 200A at a position at which USB terminal section (first terminal section) 310 and USB terminal section (first connected terminal section) 210 connect. Also, latch holes (second latched sections) 333b and 335b are engaged in a releasable fashion by upper and lower latching lugs 233 and 235 at a position at which USB terminal section 310 and other terminal section 320A connect respectively to USB terminal section 210 and other terminal section 220A.

By this means, when plug 300A is inserted into and mates with receptacle 200A, and upper and lower latching lugs 233 and 235 slide along the upper surface of shield case 332 of plug 300 and engage in latch holes 333a and 335a, USB terminal sections 210 and 310 are connected.

Also, when plug 300A is inserted more deeply into receptacle 200A, upper and lower latching lugs 233 and 235 are disengaged from latch holes 333a and 335a, slide along the upper surface of shield case 332, and engage in latch holes 333b and 335b. At this time, USB terminal section 310 and other terminal section 320A become connected to USB terminal section 210 and other terminal section 220A respectively.

Therefore, when a user inserts plug 300A into receptacle 200A, the user can be made aware intuitively of the connection of USB terminal sections 210 and 310, and the connection of USB terminal sections 210 and 310 and other terminal sections 220A and 320A, by the engagement of upper and lower latching lugs 233 and 235 in latch holes 333a, 335a, 333b, and 335b.

That is to say, when plug 300A is inserted further into receptacle 200A from the half-locked first-stage connection state, the half-lock state is released, and then plug 300A is half-locked again, and the fact that the second-stage connection state has been established can be conveyed intuitively to the user.

In connector apparatus 100A of this embodiment, the respective contact positions of USB terminal section 310 and other terminal section 320 are staggered in the direction of insertion of 300 and vertically, and the contact position of USB terminal section 310 is located further on the plug insertion direction side than the contact position of other terminal section 320.

That is to say, the contact position of USB terminal section 210 is located at the front of receptacle housing 240A—that is, at the front of shield case 230—and the contact position of other terminal section 220A is located at the rear of receptacle housing 240—that is, at the rear of shield case 230.

Therefore, when plug 300A is inserted into receptacle 200A, USB terminal section 210 is connected to plug-side USB terminal section 310 before other terminal section 220 is connected to plug-side other terminal section 320. Also, USB terminal section 210 does not come into contact with plug-side other terminal section 320 when connecting to USB terminal section 310 on the plug 300A side.

In this way, receptacle 200A and plug 300A in connector apparatus 100A of this embodiment enable the same kind of operational effects to be obtained as with receptacle 200 and plug 300 of Embodiment 1.

Thus, with connector apparatus 10A, when plug 300A is inserted into receptacle 200A, USB connection and connection of a separate signal other than a USB signal can be performed by means of a two-stage connection process, in the same way as with connector apparatus 100 of Embodiment 1.

With above-described connector apparatus 100A of this embodiment, simply connecting plug 300A to receptacle 200A enables a USB signal to be transmitted and also enables a separate signal other than a USB signal to be transmitted. Also, when connection is made, terminals transmitting a USB signal can both be securely connected without coming into contact with terminals transmitting a separate signal other than a USB signal.

Furthermore, receptacle 200A also allows the insertion and connection of a conventional USB-A standard plug. That is to say, shield case 230 is formed as compatible with USB-A based on the USB standard. By this means, it is possible for a plug compatible with the USB-A standard to be fitted inside receiving section 230a of shield case 230, and for a USB-A compatible plug to be inserted into this receiving section 230a.

Moreover, plug 300A can also be inserted into a socket compatible with a conventional USB standard plug.

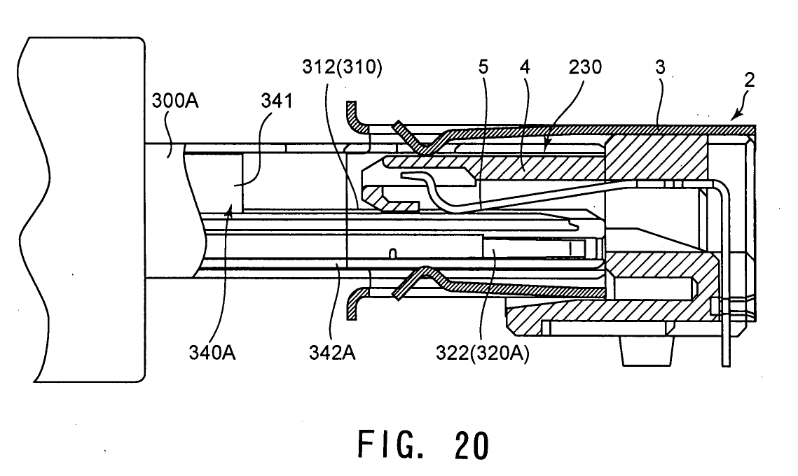

FIG. 20 is a drawing showing a state in which a plug according to Embodiment 2 of the present invention has been connected to a conventional USB socket.

USB socket 2 shown in FIG. 20 is configured in conformity with the USB-A standard in the same way as USB socket 2 shown in FIG. 13, and when a plug conforming to the conventional USB-A standard is connected, contact pins 5 of gripping plate section 4 in case 3 are located at positions at which they are connected to the connecting terminals of the USB plug. In contrast, plug 300A of Embodiment 2 internal configuration, like plug 300, differs from a conventional USB-A standard compatible plug in length and the internal configuration of the base section, while having the same external shape.

Therefore, when plug 300A is inserted into conventional USB-A standard USB socket 2, upper and lower latching lugs 3a and 3b of case 3 are engaged in latch holes 333a and 335a. By this means, USB signal transmission can be performed when connected terminals 312 of USB terminal section 310 are connected to contact pins 5—that is, when plug 300A is half-locked in a state of USB connection to USB socket 2.

Connector apparatuses 100 and 100A according to the above embodiments not only enable the connection of USB terminal sections that perform USB connection, but are also capable of transmitting a separate signal other than a USB module compatible signal such as a control signal or the like, without the occurrence of a fault.

Thus, with devices connected via connector apparatus 100/100A, it is possible for one device to identify the type of the other device, and perform operational control of that other device, simply by connecting receptacle 200/200A and plug 300/300A configuring connector apparatus 100/100A.

Plugs 300 and 300A in connector apparatuses 100 and 100A according to the embodiments each have USB terminal section (first connecting terminal section) 310 conforming to the USB standard with contacts provided on the surface of base section 342/342A, and other terminal section (second connecting terminal section) 320/320A with contacts provided on the inner surface of base section 342/342A. The contact positions of these USB terminal sections 310 and the contact positions of other terminal sections 320/320A are located at different positions in the direction of insertion into receptacle 200/200A.

In other words, plug 300/300A is connected to receptacle 200/200A having a plurality of connected terminals, and has USB terminal section (first connecting terminal section) 310 with contacts provided on the surface of base section 342/342A, and other terminal section (second connecting terminal section) 320/320A with contacts provided on the inner surface of base section 342/342A; and only USB terminal section 310 connects to connected terminals of either receptacle 200 or 200A in a first insertion state, and both USB terminal section 310 and other terminal section 320/320A connects to receptacle 200/200A connecting terminals in a second insertion state.

Also, plug 300/300A has a plurality of contact sections located at positions at different depths of insertion into receptacle 200/200A, and engaging sections (latch holes 333a, 333b, 335a, 335b) that engage and position the plurality of contact sections at a plurality of insertion depth positions in receptacle 200/200A; and the state of contact between the plurality of contact sections and contact sections on the receptacle 200 side differs according to the insertion depth. Furthermore, one of a plurality of contact sections (USB terminal section 310) has a predetermined depth in the direction of insertion, and makes contact with an identical contact section (for example, USB terminal section 210/210A) of receptacle 200/200A at any of a plurality of insertion positions. In this case, another one of a plurality of contact sections may not make contact with a contact section of receptacle 200/200A at a shallow insertion position but may make contact with a contact section of receptacle 200/200A at a deep insertion position. Engaging sections (for example, latch holes 333a and 333b) are provided as a plurality corresponding to the plurality of contact sections, and engage with an engaged section (for example, above-mentioned upper latching lug 233) provided on the receptacle 200/200A side at a plurality of positions of differing insertion depth. Moreover, the engaging sections (latch holes 333a and 333b) are provided on the same surface, and engage sequentially with the same latching section (for example, above-mentioned upper latching lug 233) provided on the receptacle 200/200A side.

By this means, when plug 300/300A is inserted into receptacle 200/200A, plug 300/300A can be inserted in stages into receptacle 200/200A at a first or second insertion state or insertion depth position. In this way, USB terminal section 210/210A of receptacle 200/200A is connected to USB terminal section 310 without other terminal section 220/220A of receptacle 200/200A being brought into contact with USB terminal section 310 of plug 300/300A. Then, other terminal section 220/220A of receptacle 200/200A is connected to other terminal section 320/320A without USB terminal section 210 of receptacle 200/200A and other terminal section 320/320A being brought into contact. Also, since an identical latching section (above-mentioned upper latching lug 233) provided on the receptacle 200/200A side engages sequentially with engaging sections (latch holes 333a and 333b) provided on the same surface, when moving between engaging positions, movement can be performed by sliding smoothly across the surface to a position in accordance with a predetermined insertion position or insertion depth.

Thus, with connector apparatus 100 of this embodiment, simply connecting plug 300 to receptacle 200 enables a USB signal to be transmitted through the connection of USB terminal sections 210 and 310, and also enables a separate signal other than a USB signal to be transmitted through the connection of other terminal sections 220 and 320.

This concludes a description of embodiments of the present invention.

The present invention is in no way limited to the above-described embodiments, and various variations and modifications may be possible without departing from the scope of the present invention.

Thus, a connector apparatus according to the present invention has an effect of enabling transmission of another signal separate from a signal transmitted by certain terminal sections, such as a USB module compatible signal, without the occurrence of a fault, when certain terminal sections are connected, such as in USB connection, and is useful as a USB transmission interface compatible with a USB standard that connects electronic devices.

What is claimed is:

1. A receptacle that mates with an inserted plug and is connected to said plug, and comprises a first connected terminal section and a second connected terminal section that are connected respectively to a first connecting terminal section and second connecting terminal section of said plug,
wherein respective contact positions of said first connected terminal section and second connected terminal section corresponding respectively to said first connecting terminal section and said second connecting terminal section are positions that are staggered in a direction of insertion of said plug.

2. The receptacle according to claim 1, wherein a contact position of said first connected terminal section and a contact position of said second connected terminal section are staggered in a direction orthogonal to a direction of insertion of said plug.

3. The receptacle according to claim 1, wherein said first connected terminal section is a connected terminal section for USB signal use.

4. The receptacle according to claim 3, wherein:
a contact position of said first connected terminal section and a contact position of said second connected terminal section are staggered in a direction orthogonal to a direction of insertion of said plug, and
a contact position of said second connected terminal section is located further in a direction of insertion of said plug than a contact position of said first connected terminal section.

5. The receptacle according to claim 1, wherein contact positions of said first connected terminal section and second connected terminal section are located respectively in upper and lower areas in a mating area of said plug when viewed from an insertion direction side.

6. A plug that is connected by being inserted into and mating with a receptacle, and comprises a first connecting terminal section and a second connecting terminal section that are connected respectively to a first connected terminal section and second connected terminal section of said receptacle,
wherein contact positions of said first connecting terminal section and second connecting terminal section corresponding respectively to said first connected terminal section and said second connected terminal section are positions that are staggered in a direction of insertion of said plug.

7. The plug according to claim 6, wherein a contact position of said first connecting terminal section and a contact position of said second connecting terminal section are staggered in a direction orthogonal to a direction of insertion of said plug.

8. The plug according to claim 6, wherein said first connecting terminal section is a connecting terminal section for USB signal use.

9. The plug according to claim 8, wherein:
a contact position of said first connecting terminal section and a contact position of said second connecting terminal section are staggered in a direction orthogonal to a direction of insertion of said plug, and
a contact position of said first connecting terminal section is located further in a direction of insertion of said plug than a contact position of said second connecting terminal section.

10. The plug according to claim 6, wherein contact positions of said first connecting terminal section and second connecting terminal section are located respectively in upper and lower areas in a mating area for said plug when viewed from an insertion direction side.

11. A plug comprising:
a shield case longer than a shield case conforming to a USB standard that is inserted into a receptacle from a front aperture side;
a plate-shaped base section that is positioned inside a shield case along a lengthwise direction of that shield case and has a peripheral surface shape conforming to a USB standard;
a USB terminal section that is positioned conforming to a USB standard on a surface of said base section and, when inserted into said receptacle, connects to a USB connected terminal section for USB signal transmission of that receptacle; and
an other connecting terminal section positioned inside said base section, used for a separate signal different from a USB signal when inserted into said receptacle,
wherein said other connecting terminal section is positioned in said base section so that a contact position thereof is a position that is staggered in a direction of insertion relative to a contact position for said USB connected terminal section of said USB terminal section.

12. A connector apparatus comprising:
a plug having a first connecting terminal section and second connecting terminal section; and
a receptacle having a first connected terminal section and a second connected terminal section that are connected respectively to said first connecting terminal section and said second connecting terminal section through said plug being inserted and mating,
wherein contact positions of said first connecting terminal section and said first connected terminal section, and contact positions of said second connecting terminal section and said second connected terminal section, are staggered in a direction of insertion of said plug.

13. The connector apparatus according to claim 12, wherein said first connecting terminal section and said first connected terminal section are terminal sections for USB signal use.

14. The connector apparatus according to claim 13, wherein:
a first contact position of said first connecting terminal section and first connected terminal section, and a second contact position of said second connecting terminal section and said second connected terminal section, are staggered in a direction orthogonal to a direction of insertion of said plug, and
said second contact position is located further in a direction of insertion of said plug than said first contact position.

15. The connector apparatus according to claim 12, wherein said plug comprises:
a first latched section that engages in a releasable fashion with a latching section of said receptacle at a position at which said first connecting terminal section connects to said first connected terminal section when that plug is inserted into and mates with said receptacle; and
a second latched section that engages in a releasable fashion with said latching section at a position at which said first connecting terminal section and said second connecting terminal section connect respectively to said first connected terminal section and said second connected terminal section.
